(19) United States
(12) Patent Application Publication
(10) Pub. No.: US 2004/0163296 A1
(43) Pub. Date: Aug. 26, 2004

(54) Hand position and orientation indicator

(76) Inventor: Shanna Marie Cronan, Greenbrae, CA (US)

Correspondence Address: Shanna Marie Cronan, 50 Via Belardo #13, Greenbrae, CA, 94904, US

(21) Appl. No.: 10/622,987

(22) Filed: Jul. 18, 2003

Related U.S. Application Data
(60) Provisional application No. 60/396,616, filed on Jul. 19, 2002.

(51) Int. Cl. G09F 3/10

(52) U.S. Cl. 40/638

(57) ABSTRACT

Embodiments of the present invention provide methods and apparatuses for indicating optimal hand position and orientation for holding or grasping a device. For one embodiment, the indicator includes an illustration of a human hand indicating proper handling position and orientation. For such an embodiment, the indicator may adhesively affix to the device to be held. In another embodiment the indicator may include instructions (e.g., written instructions) that indicate proper hand position and/or orientation. In various alternative embodiments, the indicator may be used to indicate handling position and or orientation to promote safe use of the device or to promote optimal efficiency or device use.

### CLAIM OF PRIORITY

The present application is related to, and hereby claims priority from Provisional Application Number, 60/396,616, filed on Jul. 19, 2002, and entitled, Grip-O's. The present application hereby incorporates the related provisional application by reference.

### FIELD OF THE INVENTION

This invention relates generally to the broad area of tools and devices that require a user to hold or grasp some portion of the tool or device and more specifically to methods and apparatuses to facilitate the proper holding or grasping of such tools and devices.

### BACKGROUND OF THE INVENTION

There are a tremendous number of devices that require a user to hold or grasp the device. Of these many require that the user's hand(s) be oriented in a particular way in order to use the device effectively and/or safely. For example, the incorrect handling of many device can lead to their misuse resulting in injury or death to the user or others. The consequences of such injuries and deaths are far reaching and can cause pain and sorrow, and financial loss to the injured person and their families and add a large burden to our society's human and financial resources. As one example, consider medical walkers and canes that are commonly used by the frail and elderly as a tool for walking. If held improperly theses devices are prone to cause the user to fall. Falls are the number one cause of death from injuries in the elderly population in the United States. Falls are also the leading cause of nonfatal injuries and hospitalization for trauma among the older adults in the U.S. Older adults are the primary users of medical walkers and canes. Falling increases with age. Greater than one third of adults sixty-five years and older fall every year. There are over 323,000 hip fractures per year in the United States, which costs $12.6 billion annually in medical fees lost wages and costs. The average cost of a fractured hip is $37,000.00 per person. By the year 2050 it is predicted that there will be over 500,000 hip fractures per year due to our aging population. More than 24% of people with hip fractures die as a result of the hip fracture or the medical conditions that develop as a result of the hip fractures. According to the Center for Disease Control and Prevention in 1999 about 10,000 people ages 65 and older died from fall related injuries. More than 60% of the people who die from falls are 75 years and older. Those who fall are four to five times more likely to be admitted to a long term care facility for one year or longer. Most fractures in the elderly are caused by falls. There were between 360,000 to 480,000 fractures related to falls in the elderly population in the United States every year. These fractures most often occur in the vertebrae, hip, forearm, leg, ankle, pelvis, upper arm and hand. Hip fractures increase with age, as does the use of medical walkers and canes. Hip fractures were responsible for 338,000 hospital admissions. After their hospitalization 25% of these patients with hip fractures were placed in an institution such as a skilled nursing facility, acute rehabilitative unit, or a home health program for at least one year. While they are staying in the institution, they are at increased risk to fall again. Falls which result in hip fractures often leaves these people unable to walk. Four out of ten patients are unable to walk without total assistance six months after the hip fracture. Total assistance means two people plus medical equipment is necessary to enable this person to walk. A study of hip fracture patients found that when patients required moderate to total assistance for walking or stair climbing prior to the hip fracture there was less chance of returning to their normal level of walking after the fracture. If they had chronic medical conditions, their chance of dying after the fracture increased. Falling also causes psychological problems and fear of falling again, and it has a profound impact on the family and caregivers. Family members often care for the injured relative at home resulting in loss of wages, stress, depression and injuries to themselves caused by lifting, turning the patient in bed or moving them from a bed to a chair. Cerebral aneurysm and sudden death resulting from head trauma are examples of the serious life threatening and fatal injuries caused by falls. Falls are the leading cause of traumatic brain injury according to the Center for Disease Control. Other examples of injuries caused by falls and the misuse of walkers and canes are bruising, cuts and tears of the skin, some of which require suturing and antibiotic medications and medical follow up. Some of these wounds become infected and need surgery in order to heal. The recovery time of the elderly is a substantially longer period of time and their other preexisting medial conditions often worsen during their convalescence because their general health is compromised due to fracture or whatever injury they sustained during the fall. This contributes to an increased amount of time and money and risk of complications during their recovery phase. Other potential complications during the recovery phases are impaired circulation and the nervous conduction to the affected limb or area of the fracture. This can cause impaired sensation, skin and deep tissue ulcers and breakdown, the need for medication, debridement and surgery. This occurs frequently with diabetics. One of the most serious side effects of fractured ones, especially the long bones of the legs and hips is the increased chance of developing thrombi and emboli (blood clots). These are life threatening and often fatal. These conditions often require hospitalization and a prolonged recovery at home with attendant care of admission to a skilled nursing facility.

Medical walkers are canes are just one example of the dangers and costs of mishandling devices. Exercise and sports equipment, power tools, vehicle steering devices, and house appliances, are several others. All of these devices are subject to mishandling by a user resulting in injury.

Efficient methods and apparatuses for indicating proper hand orientation when handling such devices would reduce the potential for mishandling.

### BRIEF DESCRIPTION OF THE DRAWINGS

The present invention is illustrated by way of example, and not limitation, by the figures of the accompanying drawings in which like references indicate similar elements and in which:

FIG. 1 is an illustration describing the implementation of the hand position indicator and orientation device on a medical walker;

FIG. 2 is an illustration of the hand position indicator and orientation device in the shape of a pair of hands, a right hand and a left hand;

FIG. 3 illustrates an embodiment of the indicator as an arrow with an adhesive backing to indicate proper hand position on a device; and

FIG. 4 illustrates a process by which an optimal position and orientation for holding a device is indicated in accordance with one embodiment of the invention.

### DETAILED DESCRIPTION

Overview

Embodiments of the present invention provide methods and apparatuses for indicating optimal hand position and orientation for holding or grasping a device. For one embodiment, the indicator includes an illustration of a human hand indicating proper handling position and orientation. For such an embodiment, the indicator may adhesively affix to the device to be held. In another embodiment, the indicator is visible in darkened or poorly lights environments. That is, the indicator may be made of a material that is visible in the absence of an external light source, example phosphorescent (glow-in-the-dark) material. In alternative embodiment the indicator may include instructions (e.g., written instructions) that indicate proper hand position and/or orientation. In various alternative embodiments, the indicator may be used to indicate handling position and or orientation to promote safe use of the device or to promote optimal efficiency of device use.

In the following description, numerous specific details are set forth. However, it is understood that embodiments of the invention may be practiced without these specific details. In other instances, well-known structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

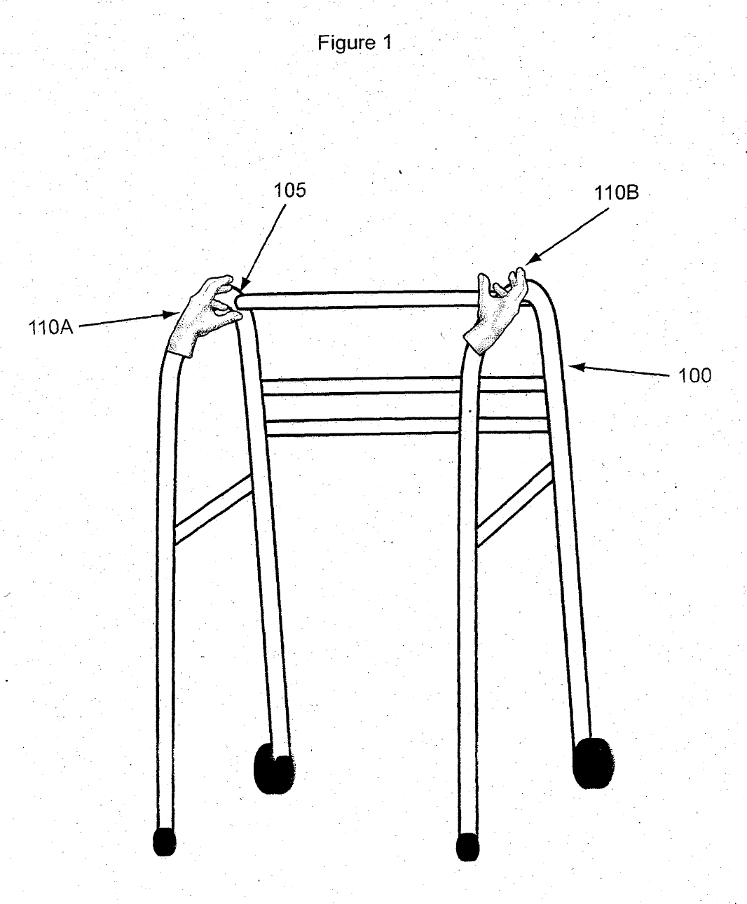

FIG. 1 is an illustration describing the implementation of the hand position indicator and orientation device on a medical walker (#100). Medical walkers are an exemplary application of use of this hand position and orientation indicator, but it is only one of many of its embodiments. There could be other ways of doing this #105 is an illustration describing where to hold a device or where to place one's hands on a device. Embodiments of the present invention provide methods and apparatuses for indicating optimal hand position #110A and #110B and orientation #105. One embodiment for optimal hand position and orientation to a device would be individualized placement of the device 110A and 110B. This could be done with the assistance of a physical therapist or other health professional with the example of a medical walker. For such an embodiment, the indicator may adhesively affix or affix with velcro or some other way to the device to be held #110A, #110B, #105. In another embodiment, the indicator is visible in darkened or poorly lighted environments. #105, #110A, #110B.

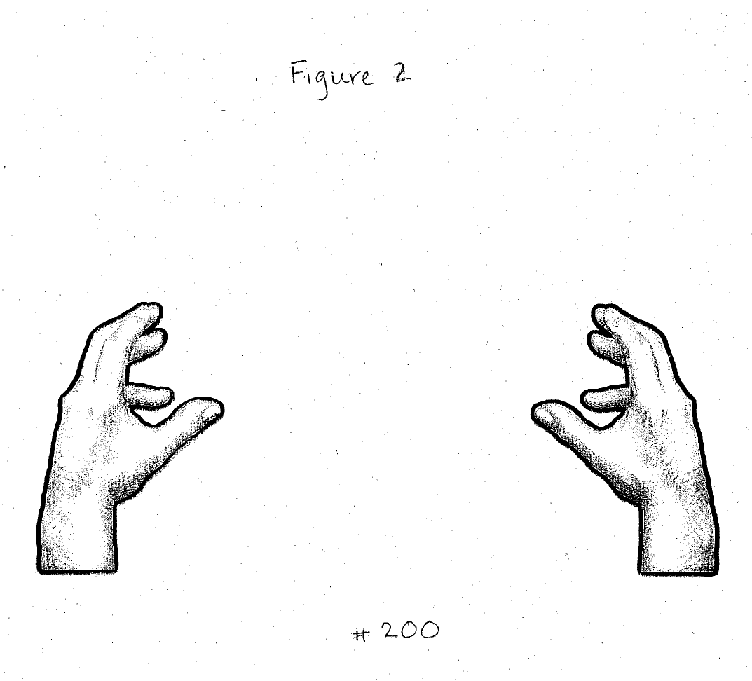

FIG. 2. is an illustration of the hand position indicator and orientation device in the shape of a pair of hands, a right hand and a left hand #200. It does not have to be in the shape of a pair of hands. It could be done another way. In an alternative embodiment the indicator may include instructions (e.g., written instructions) that indicate proper hand position and/or orientation. There could be writing on the hands.

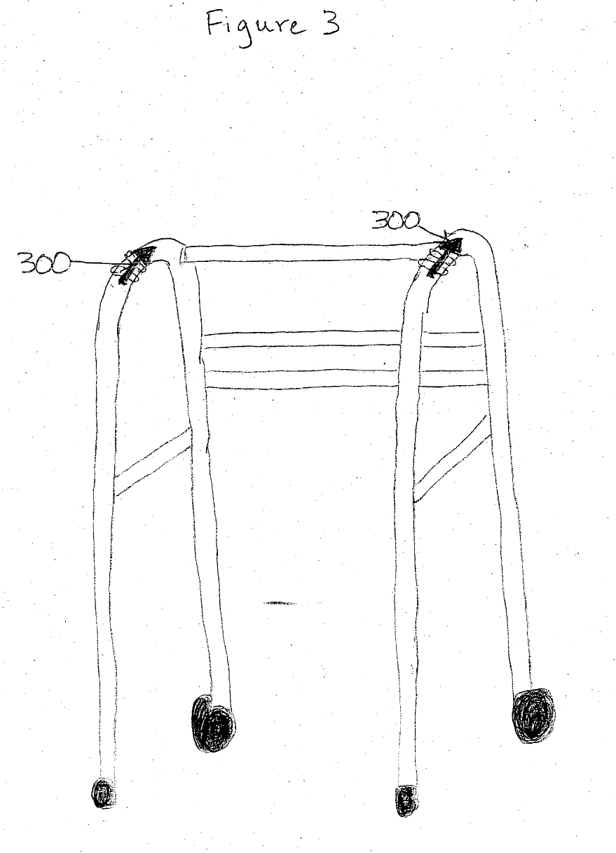

FIG. 3. illustrates an embodiment of the indicator as an arrow with an adhesive backing to indicate proper hand position on a device. It could be arrows #300 or other signage. It could be made with an adhesive material, or velcro or fastened in any way to a device and to make its position to the device adjustable #300. It could be made out of cloth or any washable material. It could be made out of paper, or different materials or composition of different materials, i.e. mylar, polyurethane, plastic, rubber, metal or other materials. It could be made of different textures, in different colors and sizes and shapes, in phosphorescent and non-phosphorescent materials, and any disposable materials. The indicator could be written instructions or signage, i.e. the indicator could be just the letter L and the letter R indicating proper placement of the left and right hands on the device. It could be the shape of a star or the sun or an asterisk, or an @ symbol, or the user's initials, or a dot • or a circle, or the shape of concentric circles, or a plus symbol, +, or a pound symbol, #, or the shape of a fingerprint, or an arced line or a wavy line, or a rectangular shape or square shape to indicate proper hand placement on a device. It could be the shape of a diamond, ♦, or a heart ♥ or a happy face symbol, or a plus symbol inside of a circle, ⊕. It could be done another way. In various alternative embodiments, the indicator may be used to indicate handling position and or orientation to promote safe use of the device or to promote optimal efficiency of device use.

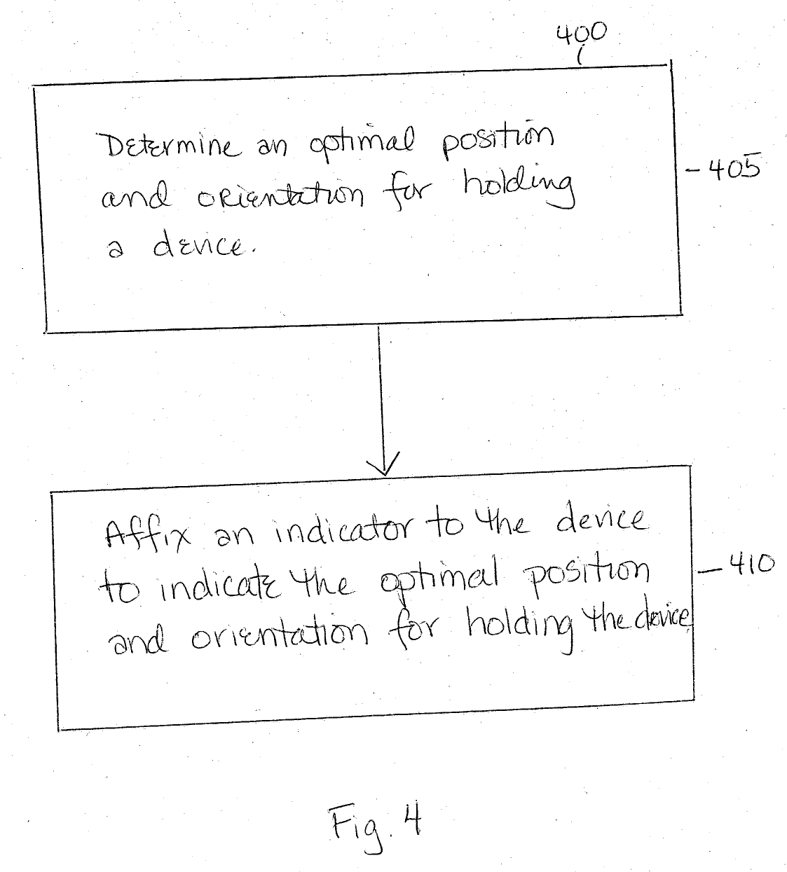

FIG. 4 illustrates a process by which an optimal position and orientation for holding a device is indicated in accordance with one embodiment of the invention. Process 400, shown in FIG. 4, begins with operation 405 in which an optimal position and orientation for holding a device is determined. For one embodiment, the optimal position and orientation may be determined, in general, by, for example, a manufacturer or distributor of the device. For example, in the case of a power tool, the manufacturer may determine the optimal position and orientation for holding the tool to reduce the potential for misuse or accidents. In an alternative embodiment, the optimal position and orientation for holding the device may be determined for a specific user. For example, the user themselves may make such a determination or a trained professional may make the determination or assist in such determination. For example, in the case of a medical walker, a physical therapist may determine the optimal position and orientation for holding the walker based upon the particular characteristics of the user. These may include for example, the user's height, weight, or medical condition, or other factors.

At operation 410, an indicator is affixed to the device to indicate the optimal position and orientation for holding the device as determined at operation 405. As described above, the indicator may be affixed in the actual optimal position such that a user holds the device right at the point the indicator is affixed. Alternatively, the indicator may be affixed adjacent to, and indicate the optimal position. The optimal orientation may be indicated in any number of ways including written instruction, indicative arrows or other symbols, or by shaping the indicator as a human hand or hands. In one embodiment in which the indicator is shaped as human hands, when the user's hands are aligned with the indicator, the user's hands will be in the optimal position and orientation for holding the device.

The following applications of this hand position and orientation indicator described above include but are not limited to use on other medical equipment (i.e. canes, grabbers, safety bars), sports and athletic equipment, tools (i.e. hand and power tools) construction equipment, and manufacturing equipment, hardware, farming equipment, office equipment, boating equipment, utensils and cooking equipment, housecleaning and janitorial equipment, playground equipment, steering wheels and handle bars of vehicles.

In the foregoing specification, the invention has been described with reference to specific exemplary embodiments thereof. It will, however, be evident that various modifications and changes may be made thereto without departing from the broader spirit and scope of the invention asset forth in the appended claims. The specification and drawings are, accordingly, to be regarded in an illustrative sense rather than a restrictive sense.

What is claimed is:

1. An apparatus comprising:
an indicator for indicating the optimal position and orientation for holding a device; and
a means for affixing the indicator to the device.

2. The apparatus of claim 1 wherein the indicator is shaped as one or more human hands.

3. The apparatus of claim 2 wherein the human hands are a right human hand and a left human hand.

4. The apparatus of claim 1 wherein the indicator is made of a material that is visible in the absence of an external light source.

5. The apparatus of claim 1 wherein the means for affixing the indicator to the device is an adhesive on the indicator.

6. The apparatus of claim 1 wherein the means for affixing the indicator to the device comprises Velcro on the indicator and corresponding Velcro on the device.

7. The apparatus of claim 1 wherein the device is a medical walker.

8. A method comprising:
determining an optimal position and orientation for holding a device; and
affixing an indicator to the device to indicate the optimal position and orientation.

9. The method of claim 8 wherein the indicator is shaped as one or more human hands.

10. The method of claim 9 wherein the human hands are a right human hand and a left human hand.

11. The method of claim 8 wherein the indicator is made of a material that is visible in the absence of an external light source.

12. The method of claim 8 wherein affixing the indicator to the device is effected through an adhesive on the indicator.

13. The method of claim 8 wherein affixing the indicator to the device is effected through Velcro on the indicator and corresponding Velcro on the device.

14. The method of claim 8 wherein the device is a medical walker.

15. The method of claim 1 wherein the optimal position and orientation for holding the device is determined by a manufacturer of the device.

16. The method of claim 1 wherein the optimal position and orientation for holding the device is determined for a specific user of the device.

17. The method of claim 14 wherein the optimal position and orientation for holding the medical walker is determined by a medical professional.
